(19) United States
(12) Patent Application Publication
(10) Pub. No.: US 2009/0320775 A1
(43) Pub. Date: Dec. 31, 2009

(54) Internal Combustion Engine

(76) Inventors: Helmut Altendorfer, Peilstein (AT); Bertram Obermayer, Hitzendorf (AT); Manfred Breitenberger, Graz (AT); Wolfgang Schöffmann, St. Veit/Glan (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 12/084,237

(22) PCT Filed: Oct. 31, 2006
(86) PCT No.: PCT/AT2006/000447

§ 371 Date: Apr. 28, 2008

(30) Foreign Application Priority Data
Oct. 31, 2005 (AT) A 1788/2005
Feb. 9, 2006 (AT) A 202/2006

(51) Int. Cl. F02F 1/40; F02F 1/42; F16H 59/04; B60K 20/00

(52) U.S. Cl. 123/41.82 R; 123/193.5; 74/473.3; 74/473.11

(57) ABSTRACT

An internal combustion engine that includes a cylinder head and a cylinder block for a multi-cylinder internal combustion engine includes at least one intake valve and one exhaust valve per cylinder, a combustion chamber covering surface adjacent to the combustion chamber, with an expansion joint being formed in the region between the individual cylinders normally to the longitudinal direction of the engine. A combustion chamber plate extending over several cylinders is arranged between the cylinder head and the cylinder block, with the expansion joint each being formed in the combustion chamber plate between two cylinders.

The invention relates to an internal combustion engine, comprising a cylinder head and a cylinder block for a multi-cylinder internal combustion engine, comprising at least one intake valve and one exhaust valve per cylinder, a combustion chamber covering surface adjacent to the combustion chamber, with an expansion joint being formed in the region between the individual cylinders normally to the longitudinal direction of the engine. The invention further relates to a switching device for a motor vehicle, comprising a transmission with a manual shift group, an input-side splitter group and an output-side range group.

In the case of multi-cylinder, four-valve internal combustion engines, the arrangement has a number of advantages in which the intake and exhaust valves are each situated in a row to the right and left of the longitudinal axis of the engine. This ensures for example that a camshaft each can be used both for the intake as well as the exhaust valves, which camshafts actuate the respective valves via cam followers and hydraulic valve adjusting elements which can be produced in a cost-effective way by production in large series.

The disadvantage in such an arrangement of the intake and exhaust valves is however that all valve reinforcing rigs between the intake and exhaust valves are situated behind one another in the middle of the engine in the longitudinal direction. Since the valve reinforcing ribs will heat up strongly during operation of the internal combustion engine, with temperatures of up to 400° C. occurring on the surface, high tensions occur as a result of the summation effect which may go beyond the amount tolerated by the material. This may lead to plastic deformations in the form of upsetting deformations. Cracks in the material may occur during the cooling down phase.

In connection with this problem, a cylinder head for a multi-cylinder internal combustion engine has become known from EP 0 785 352 B1 whose cylinder head floor comprises recesses in the area of the individual cylinders which form the upper part of the internal combustion chambers of the individual cylinders. Between the floor areas with the recesses there are areas of the cylinder head floor which are provided with a thicker configuration and comprise an expansion joint reaching from the upper side of the cylinder head floor to the bottom side.

The expansion joint can have different cross sections and can also be arranged in the web area of the cylinder head floor. One of the illustrated embodiments provides that the expansion joint, starting from the upper side of the cylinder head floor, breaks through the bottom side of the cylinder head floor

EP 0 785 352 B1 further describes an embodiment on the state of the art (FIGS. 9 and 10), in which also a cylinder head floor is shown which comprises recesses in the area of the individual cylinders and a reinforced floor section between the individual cylinders, with an expansion joint being provided in one variant, which joint originates from the bottom side of the cylinder head floor and reaches up to half the height of the recess. It has been noticed however that the floor sections situated above the expansion joints lead to a continuous plane area of the cylinder head floor with the floor sections situated above the recesses which also causes serious tensions in the material.

A 16-gear transmission for commercial vehicles is known from WO 99/00612 A1, comprising a transmission row for a direct gear version and a transmission row for an overdrive version. The transmission has a main transmission and two auxiliary transmissions, with an auxiliary transmission being arranged as a split transmission and an auxiliary transmission as a range group transmission.

Sixteen gear steps are not necessary in any case however. In simple applications, especially for lighter commercial vehicles and other applications such as busses or cranes, ten gears are fully sufficient. Current 10-gear transmissions usually consist of a manually shifted 5-gear transmission topped by a range group.

The 5-gear transmission is operated with three shift forks, with a reversal of shifting direction for the gears four and five being necessary in an overdrive transmission for outlining a standard gearshift pattern. If both types of transmission (10-gear and 16-gear transmission) are optionally desired, a considerable effort is required in respect of construction, production and logistics, which has a negative effect on costs.

It is the object of the present invention, based on the known embodiments, to further develop a cylinder head of a multi-cylinder four-valve internal combustion engine in such a way that simple production is ensured and high material tensions by thermal loads in the critical area in the longitudinal direction of the engine can be avoided. It is a further object of the invention to realize in the simplest possible way a transmission family of optionally sixteen or ten gears, with the largest possible number of similar parts being enabled.

This is achieved in accordance with the invention in such a way that a combustion chamber plate extending over several cylinders is arranged between the cylinder head and the cylinder block, with the expansion joint being formed in the combustion chamber plate.

The use of a combustion chamber plate between the cylinder head and the crankcase comes with the advantage that the wall thickness of the combustion chamber floor of the cylinder head can be reduced and the cooling in this area can be improved. This reduces the thermal strain on the cylinder head.

Thermal tensions can be compensated by the expansion joint in the combustion chamber plate.

It is preferably provided that a relief bore is arranged at each end of the expansion joint. The origination and progression of cracks at the ends of the expansion joint can be avoided by the relief bores.

In order to avoid excessive material tensions that are caused by thermal loads in critical areas of the cylinder head, it is especially advantageous when an expansion joint is also formed in the cylinder head preferably in alignment to the expansion joint formed in the combustion chamber plate. The expansion joint in the cylinder head extends starting from the bottom side facing the combustion chamber plate to the upper side of the cylinder head floor. It can be provided that the expansion joint in the cylinder head floor is bridged by a stiffening rib arranged on the upper side of the cylinder head floor and extending normally to the longitudinal axis of the engine.

The expansion joint can advantageously have a depth which substantially corresponds to the thickness of the cylinder head floor, so that in the case of a substantially plane cylinder head floor thermal expansions in this area can be caught effectively. By arranging a stiffening rib that bridges the expansion joint, the necessary resistance to deformation by the cylinder head floor is ensured in this area.

In a further development of the invention, the expansion joint can reach up into the stiffening rib. This embodiment thus allows for higher mobility and the avoidance of material tensions even under large thermal strains.

An especially advantageous embodiment of the invention provides that the expansion joint penetrates the stiffening rib at least in the area of a plane defined by the cylinder axes up to the upper side of the cylinder head floor. In this case, the stiffening rib can be arranged as a double rib in the area of the plane defined by the cylinder axis.

As a result of this special arrangement, the expansion joint can also be used as a connection between the water cooling jacket in the cylinder head and the water cooling jacket in the cylinder block. It is especially advantageous to produce the expansion joint as a milled portion in the cylinder head floor which has the shape of a segment of a circle. In comparison with known expansion joints which are produced partly originating from the upper side of the cylinder head floor and therefore need to be simultaneously formed in a complex manner together with the cylinder head, the expansion joint in the present invention can be milled starting from the bottom side.

A transmission family with optionally sixteen or ten gears can be realized in such a way that the gearshifting device is arranged as a 10-gear transmission for ten forward gears and has a double-H pattern, with eight forward gears and one reverse gear being shifted via the manual shift group and the range group and with a changeover with the splitter group only being possible between the fourth gear and the fifth gear or between the ninth gear and the tenth gear and preferably also between two reverse gears.

It is preferably provided that the sixth, seventh, eighth and ninth or tenth gear is defined by shifting the range group from low to high gear ratio.

The fourth gear or fifth gear can be arranged as a direct gear.

In order to keep the production expenditure as low as possible, it is provided in an especially preferred embodiment that the transmission unit is arranged in a substantially identical manner with a transmission unit with sixteen forward gears.

It is especially advantageous when the splitter group and/or the range group can be shifted pneumatically.

Only the fourth/fifth and the ninth/tenth gear can be shifted via the split transmission. In order to prevent the shifting of the remaining gears, a securing means is provided which is formed by the electronic system of the transmission. The electronic system of the transmission must ensure that the split transmission can only be shifted in the fourth group or ninth gear and in the reverse gear. The respective gear is recognized by means of sensors via the speed ratio of countershaft and output shaft.

The proposal in accordance with the invention provides a very simple possibility to derive a 10-gear transmission (5×2) from a 16-gear transmission (2×4×2 with input-side splitter group and output-side range group).

The splitter group from the 16-gear transmission which is shifted in an electro-pneumatic manner is used to shift the fifth gear (which also occurs in an electro-pneumatic way).

As a double-H gearshift, the gearshifting layout remains the same in principle as in the 16-gear transmission, with the fifth gear being preselected as in a splitter switch on the gear lever and is automatically shifted when actuating the clutch. Downshifting from the fifth to the fourth gear occurs similarly. The electronic system of the transmission ensures that this overdrive can only be shifted in the fourth gear and is automatically deactivated once a lower than the fourth gear is shifted mechanically. The same applies to the gears nine and ten.

The arrangement is possible as a hill-climbing gear (fifth gear=direct gear) or as an overdrive gear (fourth gear=direct gear), with the two arrangements differing in the simplest of cases only in a wheel pair of the splitter group. The reverse gear can be shifted in two gear ratios also with the help of the pneumatic splitter group.

The inside configuration of the transmission remains completely unchanged as to the arrangement of the wheels and the gearshifting. It is necessary however to change a number of wheel pairs in order to obtain a reasonable stepping of the gears. It is provided in a preferred embodiment to leave the gearwheels for the reverse gear, first gear and second gear identical with the 16-gear transmission and to make an adjustment of the number of teeth and the gear ratios in all other wheel pairs (third gear and the two other wheel pairs of the splitter group) due to meaningful gearshifting steps.

The following advantages are obtained over a conventional 10-gear transmission:
real transmission family with 16-gear transmission with a maximum of similar parts;
no changes are necessary to the principal wheel arrangement;
no changes are necessary to the mechanical gearing (shifter rods, shifter forks, lane selection, etc.);
no mechanical reversal of gearshifting direction required for the same gearshifting layout of hill-climbing and overdrive transmission.

The invention is now explained in closer detail by reference to the drawings, wherein:

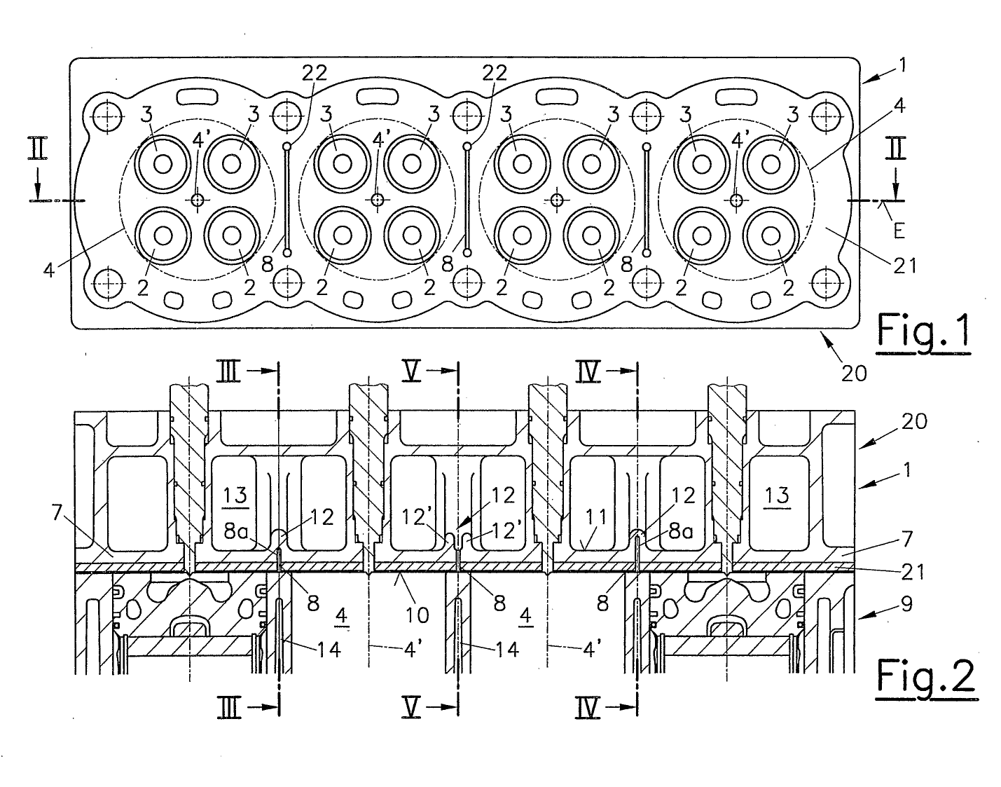

FIG. 1 shows the bottom view of a cylinder head of an internal combustion engine in accordance with the invention;

FIG. 2 shows the internal combustion engine in a sectional view along the line II-II in FIG. 1;

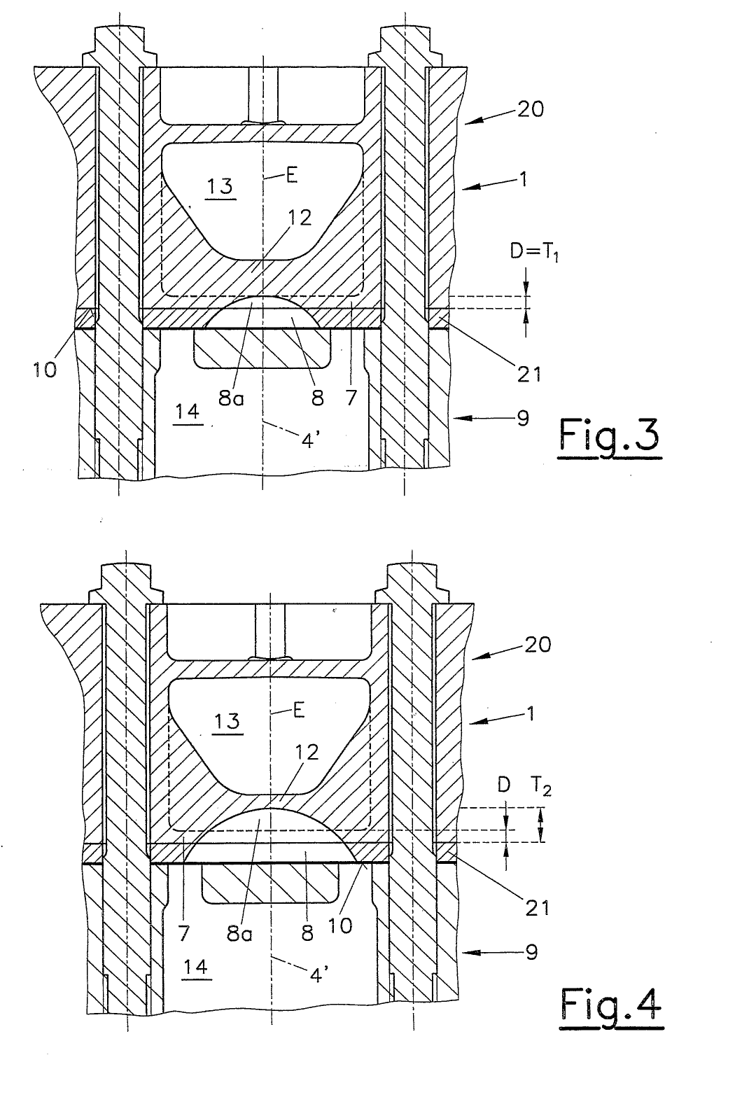

FIG. 3 shows the internal combustion engine in a sectional view along line III-III in FIG. 2;

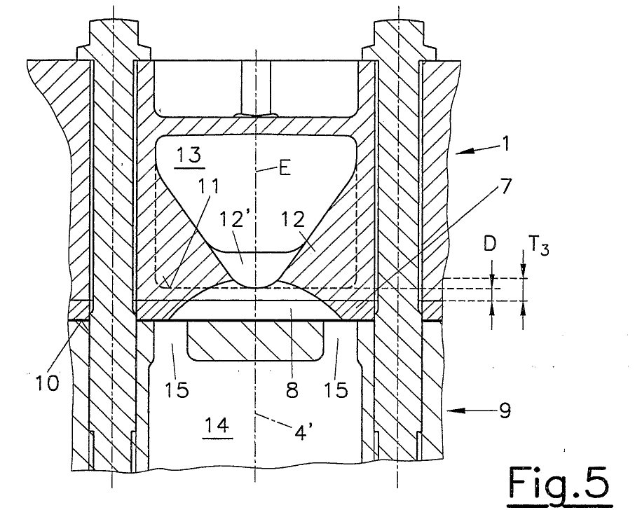

FIG. 4 shows the internal combustion engine in a sectional view according to line IV-IV in FIG. 2;

FIG. 5 shows the internal combustion engine in a sectional view according to line V-V in FIG. 2;

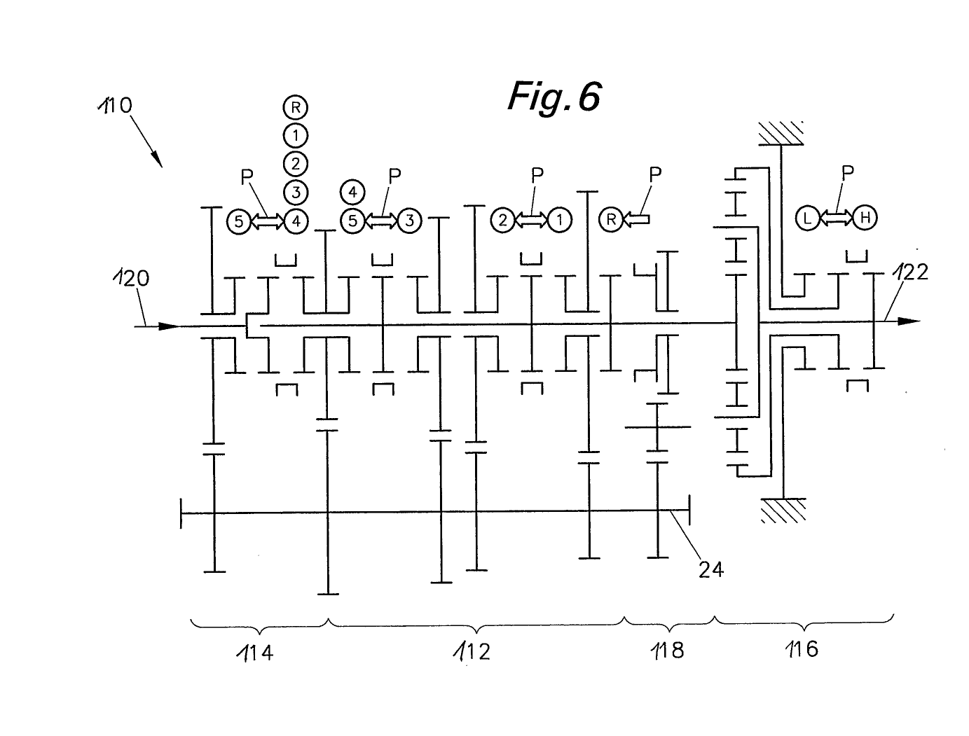

FIG. 6 shows a schematic view of a gearshifting device in accordance with the invention in a first embodiment;

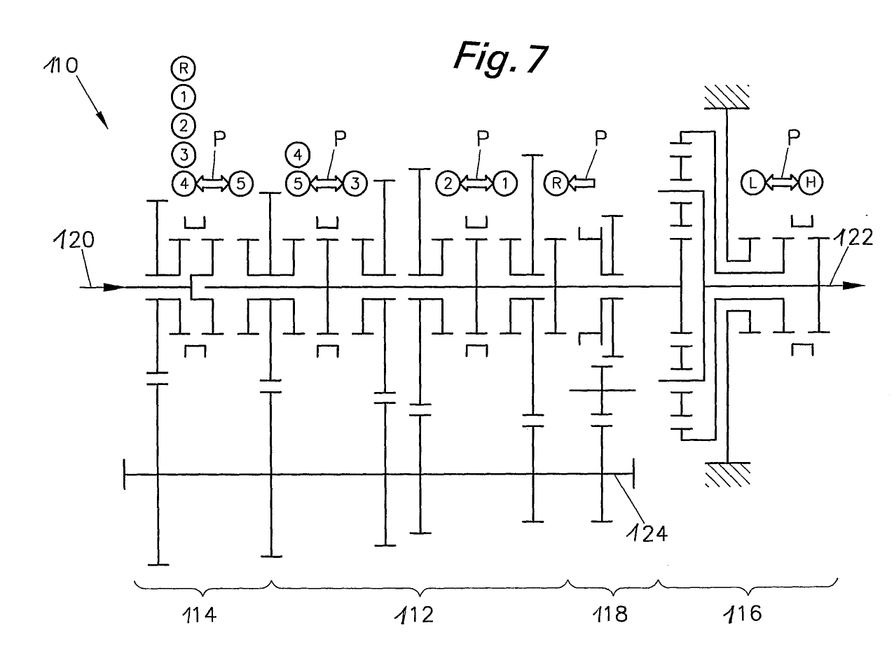

FIG. 7 shows a gearshifting device in accordance with the invention in a second embodiment and

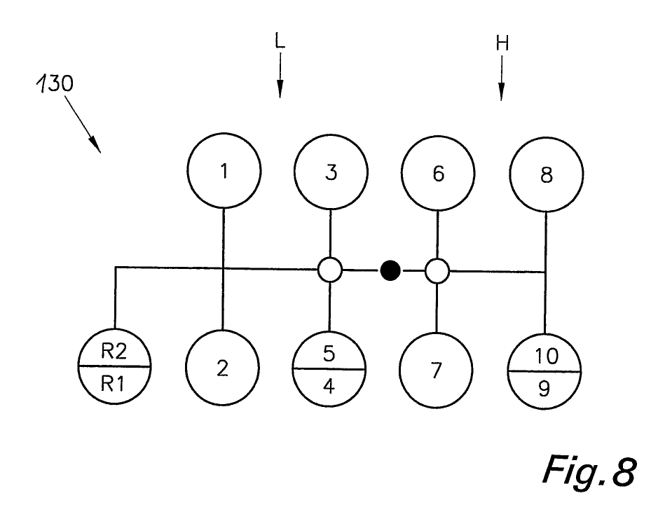

FIG. 8 shows a gearshifting layout of the gearshifting device.

The cylinder head 1 of a four-valve internal combustion engine 20 as shown in FIGS. 1 and 2, comprises intake valve openings 2 and exhaust valve openings 3 which are each arranged in a row in the longitudinal direction of the engine. The intake valve openings 2 and the exhaust valve openings 3 are situated on either side of a plane E defined by the cylinder axes 4′ of the internal combustion engine, with a camshaft each being used for both types of valves which actuates the respective valves via cam follower and hydraulic valve adjusting devices.

A substantially planar combustion chamber plate 21 is arranged between the cylinder head 1 and the cylinder block 9, which combustion chamber plate comprises an expansion joint 8 which is formed in the area between the cylinders 4 in a normal direction relative to the longitudinal direction of the engine. Material tensions caused by thermal strains can be relieved by the expansion joint 8. In order to avoid multi-axis tension states at the ends of the expansion joint 8, relief bores 22 are formed in the combustion chamber plate 21.

The cylinder head 7 which is arranged in a substantially planar way also comprises an expansion joint 8a in the area between the individual cylinders 4, which joint is aligned normally to the longitudinal direction of the engine and which originates from the bottom side 10 of the cylinder head floor 7 facing the cylinder block 9 and extends in the direction towards the upper side 11 of the cylinder head floor 7. The expansion joint 8a is bridged on the upper side 11 by a stiffening rib 12 extending normally to the longitudinal axis of the engine. The expansion joints 8a in the cylinder head floor 7 are arranged in alignment with the expansion joints 8 in the combustion chamber plate 21.

Three advantageous embodiments of the invention are shown in the sectional view according to FIG. 2 on the basis of the illustrated expansion joints 8, 8a. The embodiment shown on the left side in the illustration shows an expansion joint 8a in the cylinder head floor 7 whose depth T₁ corresponds substantially to the thickness D of the cylinder head floor 7 (see FIG. 3).

The embodiment shown in FIG. 2 on the right side shows an expansion joint 8a of the cylinder head floor 7 which reaches up into the stiffening rib 12, so that its depth T₂ is larger than the thickness D of the cylinder head floor 7.

Finally, the middle expansion joint in FIG. 2 shows an embodiment in which the expansion joint 8a of the cylinder head floor 7 penetrates the stiffening rib 12 at least in the area of the plane E defined by the cylinder axes 4′ up to the upper side of the cylinder head floor 7. As is shown in FIG. 5, the expansion joint 8a has a depth T₃ which is slightly larger than the depth D of the cylinder head floor 7. According to this embodiment, the stiffening rib 12 can be arranged as a double rib 12′ in the area of the plane E as defined by the cylinder axis 4′. With the help of the embodiment according to FIG. 5, a connection can simply be established between the water cooling jacket 13 in the cylinder head 1 and the water cooling jacket 14 in the cylinder block 9. A flow connection via the vapor holes 15 in the cylinder block 9 can be obtained through simple production especially when the expansion joints 8, 8a are arranged as milled portions in the form of a segment of a circle in the combustion chamber plate 21 and in the cylinder head floor 7.

The gearshifting device comprises a transmission 110 with a manual shift group 112, an input-side splitter group 114 and an output-side range group 116 and a reversing group 118 for the reverse gear R. Reference numeral 120 designates the input shaft, reference numeral 122 the output shaft and reference numeral 124 the countershaft.

The gearshifting processes for gears 1, 2, 3, 4, 5 and the reverse gear R are indicated with arrows P.

The gears 1, 2, 3, 4 are shifted via the manual shift group 112. Changeover can occur via the splitter group 114 between the fourth and fifth gear 4, 5. A low or high gear ratio L, H can be associated to these five gears 1, 2, 3, 4, 5 by means of the range group 116. This leads to a total of ten forward gears.

By shifting the reverse gear step 118 it is possible to shift to the reverse gear R. The reverse gear R can also be associated with two gear steps R1, R2 by the splitter group 114.

The fourth gear 4 is arranged as a direct gear in the embodiment as shown in FIG. 6. An overdrive transmission can thus be realized.

FIG. 7 shows an arrangement as a hill-climbing transmission, with the direct gear being formed by the fifth gear 5. In the simplest of cases, the two embodiments differ from each other only in a wheel pair of the splitter group 114.

In the present gearshifting device, a double-H gearshifting pattern 130 is used, as shown in FIG. 8. It is possible to change over between the low gears 1, 2, 3, 4, 5 to the high gears 6, 7, 8, 9, 10 via the range group 116 with low or high gear ratio L, H. The shifting between fourth to fifth gear 4, 5 or ninth to tenth gear 9, occurs via the splitter group 114. Furthermore, it is possible to shift between the reverse gear steps R1, R2 via the splitter group 114. The difference between the described and illustrated 10-gear transmission and a 16-gear transmission of the same family of transmissions is that in the present 10-gear transmission the shifting of the splitter group 114 to the gears 1, 2, 3 and 6, 7, 8 respectively is blocked. The 10-gear transmission has the same principal arrangement of the gearwheels as the 16-gear transmission. Merely the number of teeth and the gear ratios for the third and fourth gear are different. First and second gear can be provided with identical arrangement. 10-gear transmission and 16-gear transmission can be arranged with the same mechanical gearing (shifter rods, shifter forks, lane selection, etc.). In comparison with a conventional 10-gear transmission with a manual 5-gear gearshifting group and a downstream range group, this leads to the advantage that no mechanical reversal of gearshifting direction is required for an identical shifting pattern of hill-climbing and overdrive transmissions.

The gearshifting pattern remains as a double-H gearshifting principally the same as in a 16-gear transmission, with the fifth gear 5 being preselected with a switch and being engaged automatically upon actuating the clutch. In the same manner, downshifting occurs from the fifth to the fourth gear 4. The electronic system of the transmission ensures that this overdrive can only be shifted in the fourth gear 4 and is deactivated as soon as a gear lower than the fourth gear is mechanically engaged. For orientation purposes it is advisable to provide a display with the display of the shifted gears.

1. An internal combustion engine, comprising a cylinder head and a cylinder block for a multi-cylinder internal combustion engine, comprising at least one intake valve and one exhaust valve per cylinder, a combustion chamber covering surface adjacent to the combustion chamber, with an expansion joint being formed in the region between the individual cylinders normally to the longitudinal direction of the engine, wherein a combustion chamber plate extending over several cylinders is arranged between the cylinder head and the cylinder block, with the expansion joint being formed in the combustion chamber plate.

2. An internal combustion engine according to claim 1, wherein a relief bore is arranged at each end of the expansion joint.

3. An internal combustion engine according to claim 2, wherein an expansion joint is formed in the cylinder head in alignment to the expansion joint formed in the combustion chamber plate.

4. An internal combustion engine according to claim 3, wherein the expansion joint formed in the cylinder head floor extends from the bottom side facing the combustion chamber plate to the upper side of the cylinder head floor.

5. An internal combustion engine according to claim 4, wherein the expansion joint in the cylinder head floor is bridged by a stiffening rib arranged on the upper side of the cylinder head floor and extending normally to the longitudinal axis of the engine.

6. An internal combustion engine according to claim 5, wherein the expansion joint in the cylinder head has a depth which substantially corresponds to the thickness of the cylinder head floor.

7. An internal combustion engine according to claim 6, wherein the expansion joint reaches up into the stiffening rib.

8. An internal combustion engine according to claim 7, wherein the expansion joint penetrates the stiffening rib at least in the area of a plane defined by the cylinder axes up to the upper side of the cylinder head floor.

9. An internal combustion engine according to claim 8, wherein the stiffening rib is arranged as a double rib in the area of the plane as defined by the cylinder axes.

10. An internal combustion engine according to claim 9, wherein the expansion joint produces a connection between the water cooling jacket in the cylinder head and the water cooling jacket in the cylinder block.

11. An internal combustion engine according to claim 10, wherein the expansion joint is formed as a milled portion which has the shape of a segment of a circle.

12. A gearshifting device for a motor vehicle, comprising a transmission with a manual shift group, an input-side splitter group and an output-side range group, wherein the gearshifting device is arranged as a 10-gear transmission for ten forward gears and has a double-H pattern, with eight forward gears and one reverse gear being shifted via the manual shift group and the range group and with a changeover with the splitter group only being possible between the fourth gear and the fifth gear or between the ninth gear and the tenth gear and preferably also between two reverse gears.

13. A gearshifting device according to claim 12, wherein the sixth, seventh, eighth, ninth and tenth gear are defined by shifting the range group from low to high gear ratio.

14. A gearshifting device according to claim 13, wherein the fourth gear is arranged as a direct gear.

15. A gearshifting device according to claim 13, wherein the fifth gear is arranged as a direct gear.

16. A gearshifting device according to claim 15, wherein the transmission is arranged in the arrangement of the relevant mechanical elements, especially the shafts, gearwheels and gearshifting elements, in a constructionally similar manner with a transmission with sixteen forward gears.

17. A gearshifting device according to claim 16, wherein the splitter group and/or the range group can be shifted pneumatically.

18. A gearshifting device according to claim 17, wherein a securing means is provided for preventing that gears other than the fourth/fifth and ninth/tenth forward gear and the two reverse gears (R₁, R₂) can be shifted by the splitter group.

19. A gearshifting device according to claim 20, wherein the securing means is formed by the electronic system of the transmission.
